(19) United States
(12) Patent Application Publication
(10) Pub. No.: US 2010/0151262 A1
(43) Pub. Date: Jun. 17, 2010

(54) METALLIC COATING OF COMPOSITE MATERIALS

(75) Inventors: Thomas Joseph Corden, York (GB); Mark Raymond Steele, Derbyshire (GB)

Correspondence Address: PEARNE & GORDON LLP, 1801 EAST 9TH STREET, SUITE 1200, CLEVELAND, OH, 44114-3108, US

(73) Assignee: ADVANCED COMPOSITES GROUP LIMITED, Derbyshire (GB)

(21) Appl. No.: 12/518,523

(22) PCT Filed: Dec. 6, 2007
(86) PCT No.: PCT/GB07/04684

§ 371 Date: Aug. 17, 2009

(30) Foreign Application Priority Data
Dec. 14, 2006 (GB) 0624906.4
Jan. 19, 2007 (US) 60885668

(51) Int. Cl. B32B 15/08; B23P 19/04

(52) U.S. Cl. 428/457; 29/460

(57) ABSTRACT

A method of manufacturing a composite and of securing a metallic coating to a resin-based composite material, comprising the provision of a keying structure on a metallic electroplated preform and bringing the keying structure and the composite material together under conditions to cause the composite material and the keying structure to interlock. The invention also provides a composite comprising a resin-based composite material with a metallic coating on a surface, or part surface thereof, the metallic coating comprising an outer electroplated preform, and an inner keying structure which is located generally between said electroplated preform and the composite material to provide attachment of the electroplated preform on the composite material.

The present invention relates to the metallic coating of composite materials, particularly, but not exclusively to the application of metallic coatings to resin-based composite materials and products made therefrom.

Resin-based composites, in particular fibre-reinforced resin composites have many known advantageous properties and characteristics that enable them and products made therefrom to find applications in very many diverse industries.

There are also many applications of such materials and products that would benefit from or require a metallic surface or coating, particularly a hard metallic coating, on the composite material. For example tooling and moulds for use in the manufacture of components, including further composite components, could be longer lasting and harder wearing with a metallic coating, particularly on the tool or mould surface(s). Composite gas turbine blades and helicopter blades could have improved wear and erosion characteristics, printing rollers could be made with the advantages of the light weight and stiffness of the composite coupled with enhanced precision and better wearing properties of a metallic print surface. Composite hydraulic rams could benefit from the light weight and high strength characteristics of the composite combined with the hard metallic surface for the hydraulic seal. Composite reflector dishes, ground based mirrors, space based mirrors are other examples, to name but a few.

For many applications, it is important that the metallic coating is securely attached to the composite material. In certain applications, considerable shear forces may be experienced that would act to try to shear or tear the metallic coating from the composite. In the same or other applications, thermal stresses may be experienced that would tend to act to weaken the attachment of such a coating to a composite body.

Within this specification the term “coating” relates to a layer or other form that covers some or all of one or more surfaces.

According to the present invention there is provided a method of securing a metallic coating to a resin-based composite material, the method comprising forming a keying structure on a metallic electroplated preform to provide a coating, bringing the coating and the composite material together and subjecting to conditions to cause the composite material and the keying structure to interlock.

According to a second aspect of the present invention there is provided a method of manufacturing a composite, the method comprising securing an electroplated preform to a curable composite material by providing a keying structure on the electroplated preform with which the curable composite material interlocks, particularly when cured.

Preferably the keying structure is applied to the metallic electroplated preform; and is applied directly to be securely attached thereto.

Preferably the keying structure is metallic and is preferably fused to the electroplated preform during formation.

The keying structure may be built up on the preform and is preferably formed by spraying metallic material onto the metallic electroplated preform, preferably using a thermal spraying technique.

The keying structure may be formed using one or more of High Velocity Oxy Fuel (HVOF), Arc, plasma and/or cold spraying techniques.

The keying structure may comprise one or more of nickel-iron alloy, aluminium, aluminium alloy, invar, iron, steel, nickel, copper, titanium and alloys of any one or more of these.

Preferably the keying structure is formed from material chosen to have a thermal expansion co-efficient equal to or similar to that of the composite material and preferably the electroplated preform. This will help to prevent de-lamination or weakening of the attachment between these during any thermal changes, which may occur during processing and/or use.

Preferably the keying structure has a rough and preferably an at least partly open architecture, providing interstices within which resin from the composite material can locate to interlock and provide secure attachment.

Preferably the electroplated preform is forme using conventional electroplating techniques. The preform may be formed directly on a tool, pattern or mould to conform to one or more surfaces thereof to a predetermined shape. A release agent may be applied to the tool, pattern or mould prior to electroplating to facilitate removal of the coating therefrom. The keying structure is preferably applied to the electroplated preform in situ on the tool, pattern or mould. The electroplated preform may be formed from one or more of nickel alloy, iron alloy, invar, copper, nickel, gold, chromium and alloys of any one or more of these.

Preferably the composite material comprises a curable resinous material, which when subjected to appropriate conditions, such as elevated temperature and/or pressure conditions, migrates into the interstices of the keying structure wherein the resinous material is cured preferably to a non-flowable and preferably hard condition, to interlock and securely attach the coating to the composite material. The resinous material is preferably a thermoset resin or a blend of resins.

The composite material may comprise a fibre-reinforced composite, comprising for example one or more of glass, aramid, carbon, Kevlar, natural fibres, ceramic and any other suitable reinforcing fibres.

The composite material may comprise a prepreg or composite preform of any known type and conformation and may be in the form of a single layer or multi-layer laminate.

According to a third aspect of the present invention there is provided a composite comprising a composite material with a metallic coating on a surface or part surface thereof, the composite being formed as described in any of the preceding thirteen paragraphs.

According to a fourth aspect of the present invention there is provided a composite comprising a resinous composite material with a metallic coating on a surface or a part-surface thereof, the metallic coating comprising an outer preform formed by electroplating and a keying structure on the electroplated layer with which the composite material engages.

Preferred embodiments of the present invention will now be described by way of example only, with reference to the accompanying drawings, in which:—

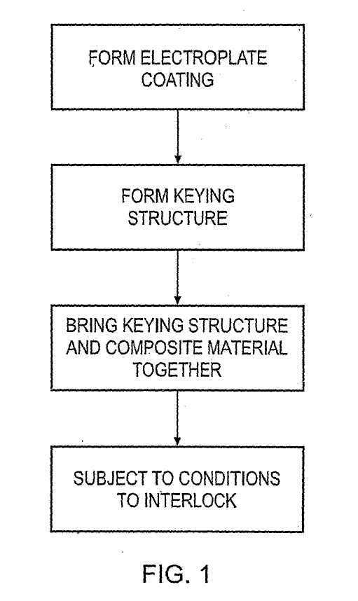

FIG. 1 is a schematic representation of a method according to the present invention;

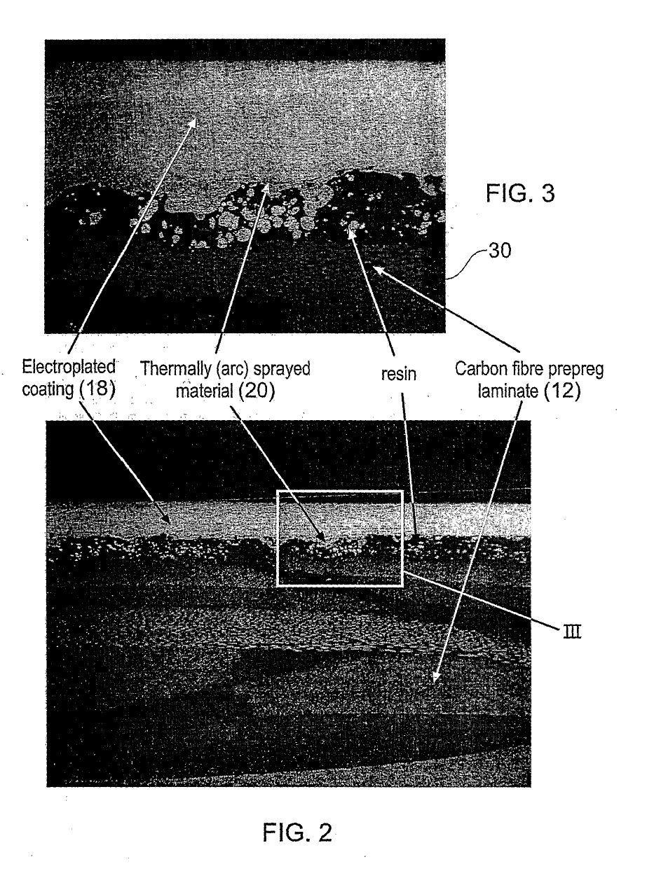

FIG. 2 is an optical microscope cross-sectional image of a composite according to the present invention;

FIG. 3 is an enlarged view of the area III of FIG. 2;

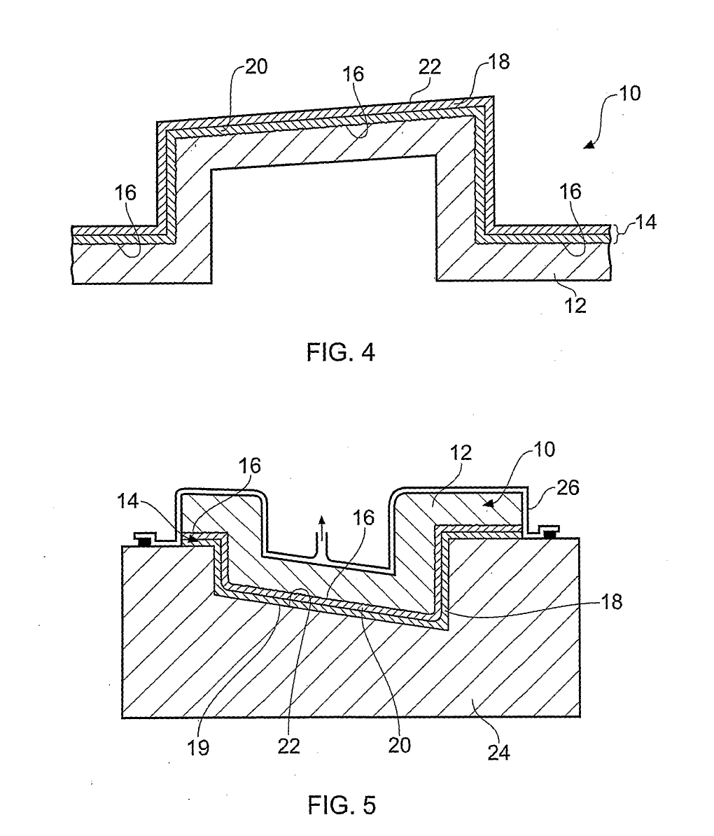

FIG. 4 is a diagrammatic cross-section of a composite according to the present invention; and

FIG. 5 is a diagrammatic cross-section of the composite of FIG. 4 during cure on a tool.

This invention relates to methods of providing a metallic coating or surface on a resin based composite material, methods of forming composites, and composites and other products formed therefrom.

With reference to FIG. 1, there is provided a method of manufacturing a composite and of securing a metallic coating to a resin-based composite material, comprising the provision a keying structure on a metallic electroplated preform and bringing the keying structure and the composite material together under conditions to cause the composite material and the keying structure to interlock.

The invention also provides a composite 10 (see particularly FIG. 4) comprising a resin-based composite material 12 with a metallic coating 14 on a surface, or part surface 16 thereof, the metallic coating 14 comprising an outer electroplated preform, in this embodiment in the form of a layer 18, and an inner keying structure 20 which is located generally between said electroplated preform 18 and the composite material 12 to provide attachment of the electroplated preform 18 on the composite material 12.

The invention also provides a composite having a metallic coating 14, formed as described herein in accordance with the methodology of the present invention.

The present invention finds particular application in the provision of a metallic coating or surface to thermoset resin-based composite materials comprising a resin or a blend of resins which set to a non-flowable, generally hard state following cure. These include, but are not limited to any one or more of epoxy phenol novolacs, epoxy novolacs, epoxy cresol novolacs, epoxys, bisphenol A epoxy resins, bisphenol F epoxy resins, multifunctional resins, multifunctional epoxy resins, phenolics, cyanate esters, BMIs, polyesters. Thermoplastic materials may be used. Such resinous materials, particularly when reinforced with reinforcing fibrous materials, such as glass, aramid, Kevlar and/or carbon, have well understood and documented properties and characteristics that provide particular advantages and beneficial application in certain industries. Other fibres can of course be used within the scope of the present invention.

The ability to provide a securely attached metallic coating or surface to such composites enables them to be used in further applications, some of which have been described hereinbefore.

It is generally important that the metallic surface or coating is securely attached to the resinous composite material, as in many applications the interface therebetween is subjected to intense shear forces and/or other forces or conditions that act to try to decouple or delaminate. It is the provision of the keying structure according to the present invention that provides interlocking and secure attachment of the metallic coating 14 and the composite material 12, as will now be described.

The electroplated preform or layer 18 is first of all formed using known electroplating techniques. It will often be the case that the electroplate layer 18 will form the working surface of the composite 10, whether as the finished surface of a product or component, or as a mould or tool surface when the composite 10 is to be used as a mould or tool on which other products will be formed.

The electroplated layer 18, is preferably formed directly on a machined or otherwise accurately profiled surface(s) 19 of a tool or pattern (as shown in FIG. 5—and as will be described later), and so will conform accurately to the desired profile, with little or no inherent porosity. This means that not only does the electroplated layer 18 provide a high quality and accurately profiled outer surface 22, but it also acts to prevent resin from the composite material 12 from moving completely through the metallic coating to appear on the outer, finished surface. Electroplating is also a relatively mild process not requiring high temperature or other conditions that could detrimentally affect tool or patterns made themselves of composite materials or other temperature sensitive or relatively soft materials.

If required, a release agent may be applied to the surface of the mould or tool prior to electroplating, to facilitate subsequent removal of the composite as described hereinafter.

Once the electroplated layer 18 is formed, then the keying structure 20 is formed on the side of the electroplated layer to which the composite material 12 will be secured.

It is envisaged that it will often be useful to form the keying structure 20 on the electroplated layer 18 whilst the electroplated layer 18 remains in position on the surface of the tool or pattern on which it has been preformed. Forming the metallic coating 14 in this way reduces any difficulties of uneven deposition of material either in the electroplated layer 18 or in the keying structure 20 from detrimentally affecting the outer surface 22.

The keying structure 20 is applied to the electroplated layer 18 by the thermal spraying of metallic material directly onto the electroplated layer 18.

There are several known techniques for spraying metallic material, such as High Velocity Oxy Fuel (HVOF), Arc, plasma and cold spray techniques. Any of these, either alone or in combination, or indeed any other suitable techniques for spraying metallic material, can be used.

The nature of these techniques generally involves driving molten droplets of metal which in this case involves driving them to fuse to the metallic electroplated layer 18. These techniques result in the keying structure 20 being strongly attach to the electroplated layer 18.

For example, High Velocity Oxy Fuel involves heating a metal powder in a high temperature gas stream resulting in the production of molten or metallic droplets which are sprayed on to the electroplate surface.

Arc spraying involves heating a metal wire between two electrodes and the molten droplets accelerated onto the surface.

High Velocity Oxy Fuel generally gives a denser coating with finer droplets than Arc spraying, but Arc spraying can lay down more material more quickly and is generally a lower temperature process.

These techniques result in the formation of a keying structure 20, having a rough, exposed architecture that could be described as having an at least partly open structure providing voids and interstices for keying of the composite material, as will be described.

Once the keying structure 20 has been formed, and generally allowed to cool sufficiently, then the resin based composite material 12 can be laminated directly on to the exposed, rough surface of the keying layer 20.

The composite material 12, as indicated previously, can take the form of any known resinous composite material, and most particularly thermoset resin based materials. The material can be a fibre reinforced material, prepregs, preforms, laminates etc.

The composite material 12 is applied in an uncured or partially cured condition. The material 12, once appropriately laminated onto the keying structure 20 is then subjected to conditions to cure or partially cure the material on the metallic coating 14.

FIG. 5 shows a diagrammatic cross-section of a composite 10, located on a tool 24, beneath a vacuum bag arrangement 26, according to known techniques of curing and consolidating resin-based composite materials. Elevated temperature conditions may be provided, again according to known techniques.

Importantly, during cure of the composite material 12, resin therefrom moves to accommodate some, and preferably most if not all of the voids and interstices of the keying structure 20. Usually during cure the resin becomes less viscous and as a consequence has a natural tendency to move to accommodate these voids and interstices. The application of pressure, using for example the vacuum bag technique as shown in FIG. 5, or other external influences will also help to force or move resin into the interstices and voids of the keying structure 20.

Once fully cured or cured to a sufficient degree, the resin sets, at least sufficiently, to key the composite material to the metallic coating 14, to provide secure attachment.

FIGS. 2 and 3 are electron microscope cross-sectional images of a composite formed according to the present invention. The relatively smooth, dense, non-porous nature of the electroplated layer 18 can clearly be seen, on the inner surface of which can be seen the keying structure 20 fused thereto. The interstices and voids can be seen with resin from the resinous prepreg, (which in this case is reinforced with carbon fibres (30)) located therein. When the resin in the structure 20 is cured and is hard and non-flowable, thus providing interlocking and a mechanical bond between, the resin based composite material and the metallic coating 14.

Once the composite 10 has been formed, it is removed from the mould or tool 24. Release agents may be used to facilitate this. The outer surface 22 of the electroplated layer 18 is generally found to be of a high quality, but if appropriate this can be further processed, perhaps by way of polishing or machining, to the desired finish.

Various modifications may be made without departing from the spirit or scope of the invention. For example, although it is generally preferable for the metallic coating and composite material to be bonded in situ on a tool, pattern or mould, they may be brought together away from the surface or tool on which the metallic coating was formed.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-31. (canceled)

32. A method of securing a metallic coating to a resin-based composite material, characterised in that the method comprises forming a keying structure on a metallic electroplated preform to provide a coating, bringing the coating and the composite material together and subjecting to conditions to cause the composite material and the keying structure to interlock.

33. A method as claimed in claim 32, characterised in that the keying structure is applied directly to the metallic electroplated preform, to be securely attached thereto.

34. A method as claimed in claim 32, characterised in that the keying structure is metallic.

35. A method as claimed in claim 32, characterised in that the keying structure is fused to the electroplated preform during formation.

36. A method as claimed in claim 32, characterised in that the keying structure is built up on the preform

37. A method as claimed in claim 34, characterised in that the keying structure is formed by spraying metallic material onto the metallic electroplated preform.

38. A method as claimed in claim 37, characterised in that the metallic material is sprayed using a thermal spraying technique.

39. A method as claimed in claim 34, characterised in that the keying structure comprises one or more of nickel-iron alloy, aluminium, aluminium alloy, invar, iron, steel, nickel, copper, titanium and alloys of any one or more of these.

40. A method as claimed in claim 32, characterised in that the keying structure is formed from material with a thermal expansion co-efficient equal to or similar to that of the composite material.

41. A method as claimed in claim 32, characterised in that the keying structure is formed from material with a thermal expansion coefficient equal to or similar to that of the electroplated perform.

42. A method as claimed in claim 32, characterised in that the keying structure has a rough architecture, providing interstices within which resin from the composite material can locate to interlock and provide secure attachment.

43. A method as claimed in claim 32, characterised in that the preform is formed directly on a tool, pattern or mould to conform to one or more surfaces thereof to a predetermined shape.

44. A method as claimed in claim 43, characterised in that the keying structure is applied to the electroplated preform in situ on the tool, pattern or mould.

45. A method as claimed in claim 32, characterised in that the electroplated preform is formed from one or more of nickel alloy, iron alloy, invar, copper, nickel, gold, chromium and alloys of any one or more of these.

46. A method as claimed in claim 32, characterised in that the composite material comprises a curable resinous material, which when subjected to appropriate conditions, such as elevated temperature and/or pressure conditions, migrates into the interstices of the keying structure wherein the resinous material is cured to interlock and securely attach the coating to the composite material.

47. A method of manufacturing a composite, characterised in that the method comprises securing an electroplated preform to a curable composite material by providing a keying structure on the electroplated preform with which the curable composite material interlocks, particularly when cured.

48. A composite material with a metallic coating on a surface or part surface thereof, the composite being formed as described in claim 32.

49. A composite material with a metallic coating on a surface or part surface thereof, the composite being formed as described in claim 47.

50. A composite material with a metallic coating on a surface or part surface thereof, the composite being formed as described in claim 46.

51. A composite comprising a resinous composite material with a metallic coating on a surface or a part-surface thereof, the metallic coating comprising an outer preform formed by electroplating and a keying structure on the electroplated layer with which the composite material engages.
